(19) United States
(12) Patent Application Publication
(10) Pub. No.: US 2023/0119284 A1
(43) Pub. Date: Apr. 20, 2023

(54) Housing Element for an Electrical Energy Store of a Motor Vehicle and Motor Vehicle

(71) Applicant: Bayerische Motoren Werke Aktiengesellschaft, Muenchen (DE)

(72) Inventors: Clemens BERGMANN, Muenchen (DE); Jonas LANG, Stockstadt (DE)

(21) Appl. No.: 17/913,938

(22) PCT Filed: May 3, 2021
(86) PCT No.: PCT/EP2021/061601

§ 371 Date: Sep. 23, 2022

(30) Foreign Application Priority Data
May 13, 2020 (DE) 10 2020 112 947.5

(51) Int. Cl. H01M 50/231; H01M 50/224

(52) U.S. Cl. CPC H01M 50/231; H01M 50/224

(57) ABSTRACT

A housing element is provided for a storage housing of an electrical energy store of a motor vehicle, the electrical energy store being designed to store electrical energy and having a plurality of storage cells which can be arranged in a receiving space of the storage housing and in which the electrical energy is to be stored. The housing element has a baseplate, which is formed from a light metal and is provided at least in a subregion with a reinforcing plate formed from a steel and is reinforced by virtue of the reinforcing plate being adhesively bonded to the subregion of the baseplate by an elastomer.

### BACKGROUND AND SUMMARY

The invention relates to a housing element for an electrical energy store of a motor vehicle. In addition, the invention relates to a motor vehicle having at least one such housing element.

WO 2010/133636 A2 discloses a kinetic energy store for an on-board power supply system of a motor vehicle. In addition, a sealing frame for use in a battery is known from EP 2 284 425 A1.

It is the object of the present invention to provide a housing element for an electrical energy store of a motor vehicle and a motor vehicle, wherein a particularly advantageous accident performance can be realized in a manner which is particularly advantageous in terms of construction space and weight.

This object is achieved by a housing element and by a motor vehicle with the features of the independent claims. Advantageous refinements of the invention are the subject matter of the dependent claims.

A first aspect of the invention relates to a housing element for a storage housing of an electrical energy store of a motor vehicle, in particular of a passenger motor vehicle, the electrical energy store being designed to store electrical energy. In its fully produced state, the energy store has the storage housing and therefore the housing element, the storage housing surrounding the housing element. The storage housing has a receiving space. In other words, the receiving space is delimited, in particular directly, by the storage housing. In its fully produced state, the electrical energy store, in which or by means of which electrical energy or electric current can be stored, has a plurality of storage cells which are referred to simply also as cells and by means of which or in which the electrical energy can be stored or is stored. In the fully produced state of the energy store, the storage cells are at least partially, in particular at least predominantly or completely, arranged in the receiving space and therefore in the storage housing. The receiving space is partially, in particular directly, delimited by the housing element. The energy store is, for example, a battery, in particular a lithium-ion battery, and therefore the respective storage cell can be designed as a lithium-ion storage cell. In particular, the energy store is a high-voltage component, the electrical voltage of which, in particular the electrical operating or nominal voltage of which, is preferably at least 48 volts or preferably greater than 50 volts, in particular greater than 60 volts. In particular, the electrical voltage, in particular the electrical operating or nominal voltage, of the high-voltage component is several hundred volts in order thereby to be able to realize, for example, particularly high electrical powers for, in particular purely, electrically driving the motor vehicle. The motor vehicle is designed here as a hybrid vehicle or as an electric vehicle, in particular as a battery-electric vehicle (BEV).

In order now to be able to realize a particularly advantageous accident performance of the storage housing and therefore of the energy store and of the motor vehicle as a whole in a manner particularly advantageous in terms of construction space and weight, it is provided according to the invention that the housing element has a baseplate, in particular at least or precisely one baseplate, which is formed from a light metal. This should be understood as meaning in particular that the baseplate is formed from at least or precisely one light metal. Expressed again in other words, the baseplate is formed from a material which comprises at least or precisely one light metal. The material is preferably a light metal alloy comprising the light metal. The baseplate is preferably designed as a plane element, and therefore the baseplate has an at least substantially flat extent. The baseplate is provided, at least in a subregion of the baseplate, with a reinforcing plate which is formed from a steel. It is preferably provided here that the reinforcing plate has an at least substantially flat extent and is therefore designed as a further plane element. The baseplate and/or the reinforcing plate are/is preferably formed integrally. The reinforcing plate reinforces the baseplate, in particular locally. The reinforcing plate is connected here to the baseplate by the reinforcing plate being adhesively bonded to the subregion and therefore to the baseplate by means of an elastomer. In other words, the reinforcing plate is adhesively bonded to the subregion and therefore to the baseplate by means of the elastomer, that is to say is adhesively bonded against the subregion and against the baseplate. The elastically deformable elastomer is therefore, for example, an, in particular elastically deformable, elastomer adhesive, by means of which the reinforcing plate, which is formed, for example, from steel sheet, is adhesively bonded flat to the baseplate, which is formed, for example, from sheet metal.

A reinforcement of the baseplate in a manner appropriate for the loading can be realized by means of the reinforcing plate and by means of the elastomer, and therefore a particularly high accident strength, which is also referred to as crash strength, of the housing element and therefore of the storage housing and of the energy store as a whole can be realized in a manner advantageous in terms of construction space and weight. In particular, a particularly high underfloor accident strength of the housing element and therefore of the energy store, which is preferably in the form of a high-voltage store, can be realized. The feature that the energy store can be in the form of a high-voltage store should be understood in particular as meaning that the energy store can be a high-voltage component. The underfloor accident strength can be understood as meaning in particular the following: in the fully produced state of the motor vehicle, the motor vehicle comprises a self-supporting body by means of which a passenger compartment, also referred to as interior, of the motor vehicle is at least partially, in particular at least predominantly or completely, delimited. The passenger compartment is also referred to as a passenger cell, with people, for example the driver of the motor vehicle, being able to stay in the passenger compartment, in particular when the motor vehicle is in motion. The body has a floor, by means of which the passenger compartment is at least partially, in particular at least predominantly or completely, delimited downward in the vertical direction of the vehicle. For example, the housing element is arranged below the floor, in particular below an underbody of the body formed by the floor, in the vertical direction of the vehicle and is at least indirectly, in particular directly, fastened to the floor or underbody. This arrangement and fastening of the housing element on the floor or underbody is also referred to as underfloor arrangement and fastening of the housing element. Since the baseplate is formed from the light metal and is reinforced, in particular locally, by means of the reinforcing plate, an excessive requirement for construction space and an excessive weight of the housing can be avoided, with a particularly advantageous accident strength being able to be realized at the same time. In particular, both a wall thickness of the baseplate and a wall thickness of the reinforcing plate can be kept particularly small, and therefore the weight and the requirement of the housing element for construction space can be kept within a particularly small scope.

It is contemplated that, in the fully produced state of the motor vehicle, the receiving space is delimited partially by the housing element and partially by the floor or by the part of the floor, in particular in each case directly. For example, the floor or at least the part of the floor is therefore a further housing element of the storage housing which can therefore comprise the housing element and the floor or at least the part of the floor. Since the floor is part of the body, which is also referred to as body shell, this part of the body is used as the further housing element and therefore for realizing the storage housing. The receiving space can thereby be designed to be particularly large, in a manner advantageous in terms of weight and construction space, and therefore a particularly large storage capacity of the energy store can be provided.

In an advantageous refinement of the invention, the reinforcing plate is separated galvanically from the baseplate by means of the elastomer. The elastomer therefore has a dual function: firstly, the elastomer is used to adhesively bond the reinforcing plate to the baseplate; secondly, the elastomer is used to separate the reinforcing plate galvanically from the baseplate. This dual function makes it possible to keep the weight and requirement for construction space particularly low.

In order to keep the weight of the housing element particularly low, it is provided, in a further refinement of the invention, that the maximum wall thickness of the baseplate is smaller than 5 mm.

The elastomer forms, for example, an elastomer intermediate layer which is referred to simply also as intermediate layer and which in particular can be elastically deformable by the elastomer being elastically deformable. The intermediate layer is arranged between the baseplate and the reinforcing plate. The intermediate layer can be adhesively bonded on one side to the reinforcing plate and on the other side to the baseplate or the subregion, as a result of which the reinforcing plate is adhesively bonded to the subregion and therefore to the baseplate by means of the elastomer. By means of this refinement, the requirement of the housing element for construction space can be kept particularly low both because of an overall particularly small thickness, for example the wall thickness, in the form of the sheet metal thickness, of the baseplate and also the reinforcing plate and by means of a reduced deformation in comparison to conventional solutions. Similarly, the weight of the housing element can be kept particularly low by the use, which is appropriate for the loading, of the reinforcing plate, which is also referred to simply as reinforcement.

In a particularly advantageous embodiment of the invention, the baseplate has a further subregion which adjoins the subregion and the reinforcing plate, extends around the entire subregion and the entire reinforcing plate and is free from a reinforcing element. The baseplate is therefore reinforced merely locally by means of the reinforcing plate, as a result of which the weight and the requirement of the housing element for construction space can be kept particularly low overall.

A further embodiment is distinguished in that the housing element has sidewalls which are spaced apart from one another, in particular along a spacing direction. The sidewalls protrude over the baseplate and the reinforcing plate, as a result of which the sidewalls and the reinforcing plate at least partially delimit the receiving space. For example, the receiving space on both sides along the spacing direction is in each case at least partially delimited by the sidewalls. In a delimiting direction running perpendicularly to the spacing direction, the receiving space is, for example, at least partially delimited by the baseplate and the reinforcing plate. In the fully produced state of the motor vehicle, the delimiting direction points downward, for example in the vertical direction of the vehicle. The housing element furthermore has at least one strut which is also referred to as transverse strut and which is arranged between the sidewalls, in particular along the spacing direction. In addition, the strut is arranged on the baseplate. The strut extends, in particular along the spacing direction, from one of the sidewalls continuously to the other sidewall and is connected, in particular at both ends, to the sidewalls, as a result of which the sidewalls are connected to one another via the strut. The sidewalls and the strut therefore form, for example, a frame by means of which a particularly advantageous accident performance can be provided in a manner which is particularly advantageous in terms of construction space and weight.

It has been shown here to be particularly advantageous if the strut is arranged on one part of the further subregion. This means that the strut is arranged next to the reinforcing plate, in particular in such a manner that the reinforcing plate is not arranged between the strut and the base, and preferably neither too is any other reinforcing element. As a result, the requirement for construction space and the weight can be kept particularly low.

In a further particularly advantageous refinement of the invention, it is provided that the reinforcing plate is connected to the baseplate exclusively by adhesive bonding brought about by means of the elastomer. This means that, with the exception of the elastomer, no other additionally connecting elements are provided by means of which the reinforcing plate is connected to the baseplate. As a result, the number of parts and the weight and the costs can be kept particularly low. Finally, it has been shown to be particularly advantageous if the light metal is aluminum. Firstly, the weight of the housing element can thereby be kept particularly low. Secondly, a particularly advantageous accident behavior can be ensured.

A second aspect of the invention relates to a motor vehicle which has at least one housing element according to the first aspect of the invention. Advantages and advantageous refinements of the first aspect should be considered to be advantages and advantageous refinements of the second aspect of the invention, and vice versa.

Further details of the invention emerge from the description below of a preferred exemplary embodiment with the associated drawings.

### BRIEF DESCRIPTION OF THE DRAWINGS

FIG. 1 is a schematic perspective view of a housing element according to an embodiment of the invention for an electrical energy store of a motor vehicle;

FIG. 2 is a schematic perspective view of a baseplate, which is provided with reinforcing plates, of the housing element;

FIG. 3 is a schematic sectional view of the baseplate which is provided with the the reinforcing plates;

FIG. 4 is, in detail form, a schematic perspective view of the housing element;

FIG. 5 is a schematic top view of the housing element; and

FIG. 6 is a schematic and perspective bottom view of the housing element.

In the figures, identical or functionally identical elements are provided with the same reference signs.

### DETAILED DESCRIPTION OF THE DRAWINGS

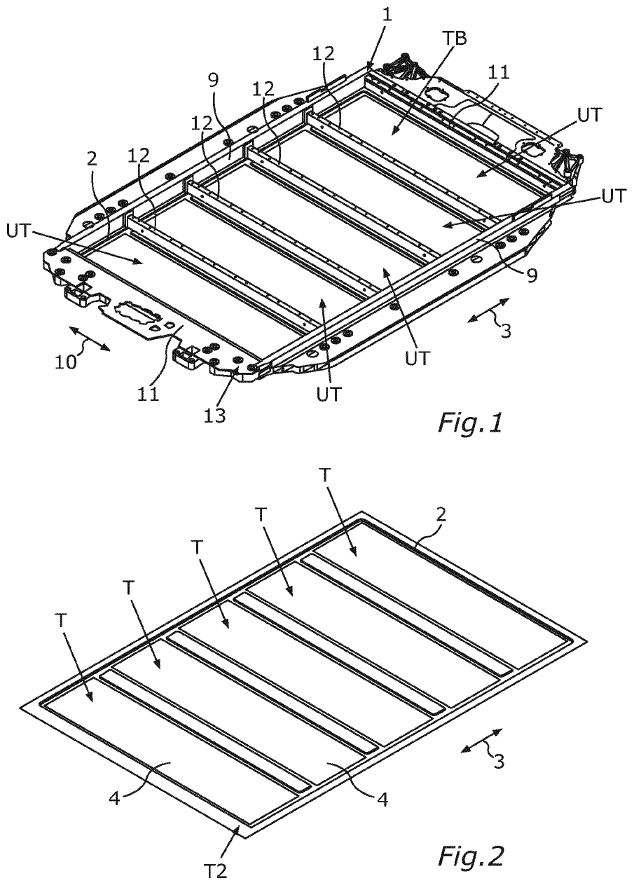

FIG. 1 shows, in a schematic perspective view, in particular in a schematic and perspective top view, a housing element 1 for an electrical energy store of a motor vehicle. This means that the motor vehicle, which is preferably in the form of a passenger motor vehicle, has, in its fully produced state, the electrical energy store mentioned, in or by means of which electrical energy or electric current can be stored or is stored. In addition, the motor vehicle has at least one electric machine by means of which the motor vehicle can be, in particular purely, electrically driven. In order to drive the motor vehicle by means of the electric machine, the electric machine is operated in a motor mode and therefore as an electric motor. For this purpose, the electric machine is provided with electrical energy which is stored in the energy store. The electric machine and the energy store are preferably high-voltage components, the respective electrical voltage, in particular electrical operating or nominal voltage, of which is preferably greater than 50 volts, in particular greater than 60 volts, and very preferably several hundred volts. The energy store is therefore also referred to, for example, as a high-voltage store.

The motor vehicle also has a self-supporting body which at least partially delimits a passenger compartment, also referred to as an interior, of the motor vehicle. People can stay in the passenger compartment when the motor vehicle is in motion. The body comprises a floor which is also referred to as body floor and by means of which the passenger compartment is at least partially, in particular at least predominantly or completely, delimited downward in the vertical direction of the vehicle.

The previously mentioned storage housing of the energy store comprises the housing element 1 which is formed separately from the body. Furthermore, the storage housing comprises at least one further housing element, not illustrated in the figures, which is, for example, in particular an integral, part of the body, which is also referred to as a body shell. The further housing comprises, for example, a part of the mentioned floor, wherein the part of the floor is also referred to as a floor element. The housing elements in each case partially delimit the receiving space, in particular in such a manner that the receiving space is completely formed or delimited by the housing elements. The energy store here has a plurality of storage cells which are also simply referred to as cells and in which the electrical energy can be stored or is stored. The storage cells are electrically connected to one another and thereby wired, for example, in parallel to and/or in series with one another. The storage cells are in each case at least partially, in particular at least predominantly or completely, arranged in the receiving space and therefore in the storage housing. A first number of the storage cells is assigned, for example, to a first storage module of the energy store, and therefore the first storage module comprises the first number of the storage cells. A second number of the storage cells is assigned, for example, to a second storage module of the energy store, and therefore the second storage module comprises the second number of the storage cells. The respective number is preferably greater than 1, in particular greater than 2. The energy store here can comprise a plurality of such storage modules, wherein the storage modules are in each case at least partially, in particular at least predominantly or completely, arranged in the receiving space and therefore in the storage housing.

The housing element 1, which is formed separately from the body, is at least partially, in particular at least predominantly or completely, arranged below the floor in the vertical direction of the vehicle, in particular in such a manner that the housing element 1 is at least partially, in particular at least predominantly or completely, covered by the floor upward in the vertical direction of the vehicle. The housing element 1 is at least indirectly, in particular directly, fastened to the floor from the bottom upward in the vertical direction of the vehicle. As a result, the housing elements are assembled or put together such that the housing elements form or delimit the receiving space, in particularly completely. Owing to the fact that at least part of the floor is used as the further housing element, the receiving space can be provided in a manner advantageous in terms of construction space and weight. In addition, the receiving space can be configured to be particularly large in a manner advantageous in terms of weight and construction space, and therefore a particularly large storage capacity of the energy store can be provided.

For example, the receiving space is at least partially, in particular at least predominantly or completely, delimited by the floor upward in the vertical direction of the vehicle. The receiving space is at least partially, in particular at least predominantly or completely, delimited by the housing element 1 downward in the vertical direction of the vehicle. The receiving space can be at least partially delimited by the body, in particular by the floor and/or by the housing element 1, forward in the longitudinal direction of the vehicle. Rearward in the longitudinal direction of the vehicle, the receiving space can be at least partially delimited by the body, in particular by the floor, and/or by the housing element 1.

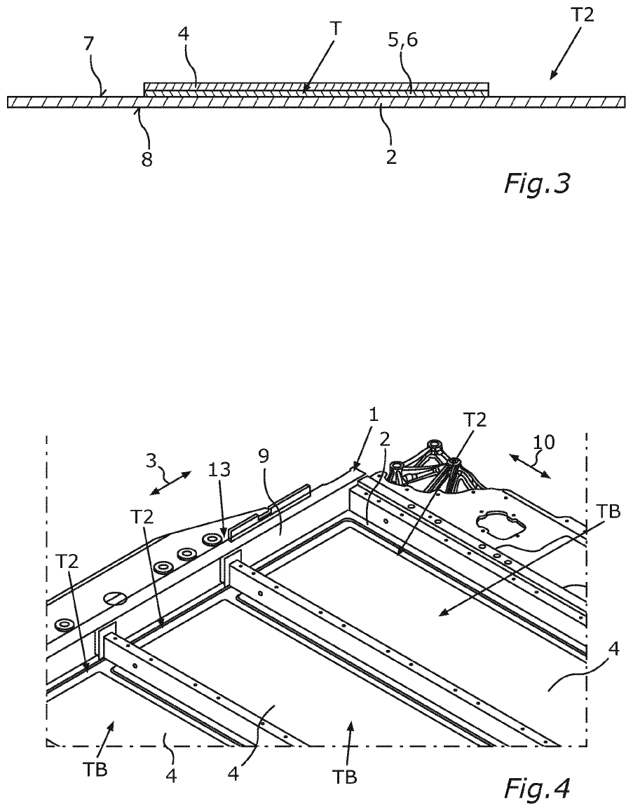

In order now to be able to realize a particularly advantageous accident performance of the housing element 1 and therefore of the storage housing and of the energy store as a whole in a manner particularly advantageous in terms of weight and construction space, the housing element 1—as can be seen particularly readily in an overall view of FIGS. 2 and 3—has a baseplate 2 which is formed from a light metal and in the present case from a light metal alloy comprising the light metal. In the exemplary embodiment shown in the figures, the light metal is aluminum, and therefore the light metal alloy is an aluminum alloy. In addition, in the exemplary embodiment shown in the figures, the baseplate 2 is designed as a plane element, and therefore the baseplate 2 has a particularly substantially flat or two-dimensional extent. In addition, the baseplate 2 is preferably formed integrally.

The baseplate 2 is provided with respective subregions T which are spaced apart from one another and are consecutive along a spacing direction, shown by a double arrow 3 in FIGS. 1 and 2, and each have precisely one, preferably integrally formed reinforcing plate 4, and the baseplate is thereby reinforced. The respective, preferably integrally formed reinforcing plate 4 is formed from a steel, as a result of which the baseplate 2 is particularly advantageously reinforced. As can be seen from FIG. 3, the respective reinforcing plate 4 is adhesively bonded to the respective subregion T of the baseplate 2 and therefore to the baseplate 2 by means of an elastomer 5. It can be seen particularly readily from FIG. 3 that the elastomer 5, which is preferably elastically deformable per se, forms an in particular elastically deformable intermediate layer 6 which is arranged between the respective reinforcing plate 4 and the respective subregion T of the baseplate 2. The respective intermediate layers 6 are also only locally provided and are therefore arranged spaced apart from one another and consecutively along the spacing direction shown by the double arrow 3. In the fully produced state of the motor vehicle, the spacing direction coincides, for example, with the vehicle longitudinal direction. Furthermore, it is provided that the respective reinforcing plate 4 is separated galvanically from the baseplate 2 by means of the respective elastomer 5. In addition, the respective reinforcing plate 4 and therefore the respective elastomer 5 are arranged on an upper side 7 of the baseplate 2 which faces upward in the vertical direction of the vehicle or faces the interior. The upper side 7 faces away from a lower side 8 of the baseplate 2, with the lower side 8 facing downward in the vertical direction of the vehicle and therefore facing away from the receiving space and from the passenger compartment.

The respective reinforcing plate 4 is also designed as a plane element and therefore has a substantially flat extent. As a result of the local reinforcement of the baseplate 2 in the respective subregions T by means of the respective reinforcing plates 4, it is possible to provide a particularly small wall thickness for the baseplate 2. It is therefore preferably provided that the maximum or greatest wall thickness of the baseplate 2 is smaller than 5 mm. As a result, the requirement for construction space and the weight can be kept within a particularly small scope.

As can be seen particularly readily from FIG. 2, the baseplate 2 has, in particular per subregion T and therefore per reinforcing plate 4, a respective further subregion T2 which adjoins the respective subregion T and the respective reinforcing plate 4 there, extends around the entire respective subregion T and the entire respective reinforcing plate 4 and is free of a reinforcing element. As a result, the baseplate 2 is only locally reinforced in the subregions T by means of the reinforcing plates 4, as a result of which the weight and the requirement of the housing element 1 for construction space can be kept particularly low. As can be seen particularly readily from FIGS. 1 and 4, the housing element 1 has sidewalls 9 which are spaced apart from one another along a further spacing direction which is shown by a double arrow 10 and runs perpendicularly to the spacing direction shown by the double arrow 3. In the fully produced state of the motor vehicle, the further spacing direction coincides with the transverse direction of the vehicle. Along the further spacing direction and therefore in the transverse direction of the vehicle, the receiving space is in each case delimited at least partially on both sides by the sidewalls 9. In addition, the housing element 1 has end walls 11 which are spaced apart from one another along the first spacing direction, shown by the double arrow 3. For example, the end walls 11 are connected to the sidewalls 9. The receiving space is in each case at least partially delimited on both sides by the end walls 11 along the first spacing direction, shown by the double arrow 3, and therefore in the longitudinal direction of the vehicle.

The housing element 1 also has struts 12 which are also referred to as transverse struts. The transverse struts are arranged between the sidewalls 9 along the further spacing direction and the between the end walls 11 along the first spacing direction and which respectively have a profile running straight or rectilinearly in the transverse direction of the vehicle or along the further spacing direction. The sidewalls 9 and the end walls 11 also have a respective, straight or rectilinear profile. The respective transverse strut extends continuously along the further spacing direction from one of the sidewalls 9 as far as the respective other sidewall 9 and is attached at both ends to the sidewalls 9, as a result of which the sidewalls 9 are connected to one another via the transverse struts and via the end walls 11. The sidewalls 9, the end walls 11 and the struts 12 therefore form a frame 13 by means of which a particularly advantageous accident performance can be realized in a particularly advantageous manner in terms of construction space and weight. In particular, it can be seen that the sidewalls 9 and the end walls 11 delimit at least one part, referred to by TB in FIG. 1, of the receiving space of the storage housing, wherein the subregion TB is delimited on both sides by the end walls 11 along the first spacing direction, shown by the double arrow 3, and on both sides by the sidewalls 9 along the further spacing direction, shown by the double arrow 10. The transverse struts are spaced apart from one another and from the end walls 11 along the first spacing direction, as a result of which the part TB is subdivided along the first spacing direction by means of the transverse struts into respective multiple lower parts UT. It can be provided here that, for example, at least or precisely one of the previously mentioned storage modules is at least partially accommodated in the respective lower parts UT. Overall, it can be seen that the lower parts UT are subspaces into which the part TB or the receiving space as a whole is subdivided by means of the struts 12. In addition, the sidewalls 9 and the end walls 11 protrude over the baseplate 2 and the reinforcing plates 4. In particular, it is contemplated that the sidewalls 9 and the end walls 11 are arranged on the baseplate 2, in particular in such a manner that the end walls 11 and the sidewalls 9 directly touch the baseplate 2 or the upper side 7 thereof.

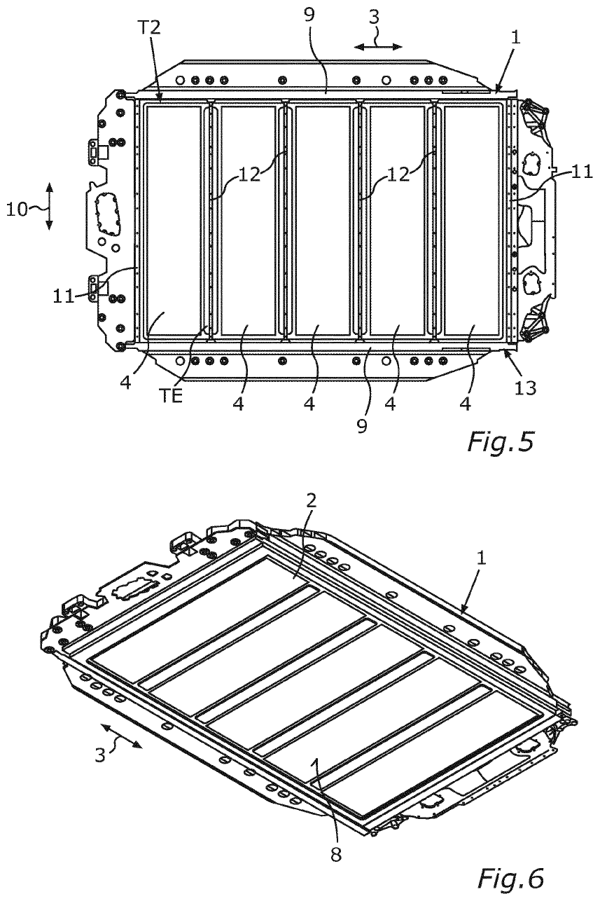

Furthermore, it can be seen particularly readily from FIGS. 4 and 5 that the respective strut 12 is arranged in a respective part TE of the respective further subregion T2 such that none of the reinforcing plates 4 is arranged between the respective strut 12 and the baseplate 2. It is contemplated here for the respective strut 12 to be supported or to lie directly on the baseplate 2 or on the upper side 7 thereof. In addition, it is provided that the respective reinforcing plate 4, which is preferably formed from sheet metal and very preferably from steel sheet, is connected to the baseplate 2, which is preferably formed from aluminum sheet, exclusively by adhesive bonding brought about by means of the respective elastomer 5. As a result, additional connecting elements for connecting the respective reinforcing plate 4 to the baseplate 2 can be avoided, and therefore the number of parts and thus the weight and the requirement for construction space can be kept particularly low.

### List of Reference Signs

1 housing element
2 baseplate
3 double arrow
4 reinforcing plate
5 elastomer
6 intermediate layer
7 upper side
8 lower side
9 sidewall
10 double arrow
11 end wall
12 strut
13 frame
T subregion
T2 subregion
TB part
UT lower part

1.-9. (canceled)

10. A housing element for a storage housing of an electrical energy store of a motor vehicle, the electrical energy store having a plurality of storage cells arrangeable in a receiving space of the storage housing, the housing element comprising:
a baseplate made of a light metal; and
at least in a subregion of the base plate, a reinforcing plate made of a steel, wherein the base plate is reinforced by the reinforcing plate; and
an elastomer by which the reinforcing plate is adhesively bonded to the subregion of the baseplate.

11. The housing element according to claim 10, wherein
the reinforcing plate is separated galvanically from the baseplate by the elastomer.

12. The housing element according to claim 11, wherein
a maximum wall thickness of the baseplate is less than 5 millimeters.

13. The housing element according to claim 10, wherein
a maximum wall thickness of the baseplate is less than 5 millimeters.

14. The housing element according to claim 10, wherein
the baseplate has a further subregion which adjoins the subregion and the reinforcing plate, extends entirely around the subregion and the entire reinforcing plate, and is free from a reinforcing element.

15. The housing element according to claim 14, wherein
the housing element has sidewalls which protrude over the baseplate and the reinforcing plate, such that the sidewalls and the reinforcing plate at least partially delimit the receiving space,
at least one strut is arranged between the sidewalls and the baseplate,
the strut extends continuously from one of the sidewalls as far as the other sidewall and thereby divides the receiving space into two subspaces, and
the strut is connected to the sidewalls, wherein the sidewalls are connected to one another via the strut.

16. The housing element according to claim 15, wherein
the strut is arranged on one part of the further subregion.

17. The housing element according to claim 10, wherein
the housing element has sidewalls which protrude over the baseplate and the reinforcing plate, such that the sidewalls and the reinforcing plate at least partially delimit the receiving space,
at least one strut is arranged between the sidewalls and the baseplate,
the strut extends continuously from one of the sidewalls as far as the other sidewall and thereby divides the receiving space into two subspaces, and
the strut is connected to the sidewalls, wherein the sidewalls are connected to one another via the strut.

18. The housing element according to claim 10, wherein
the reinforcing plate is connected to the baseplate exclusively by adhesive bonding brought about by way of the elastomer.

19. The housing element according to claim 10, wherein
the light metal is aluminum.

20. A motor vehicle comprising at least one housing element according to claim 10.
